(19) United States
(12) Patent Application Publication
(10) Pub. No.: US 2011/0100230 A1
(43) Pub. Date: May 5, 2011

(54) DEVICE FOR HEATING AND/OR FROTHING MILK FOR MACHINES FOR PREPARING HOT BEVERAGES SUCH AS A CAPPUCCINO

(75) Inventor: Rocky Cheng, Hong Kong (CN)

(73) Assignee: SWISS CAFFE ASIA LTD, Hong Kong (CN)

(21) Appl. No.: 13/001,158

(22) PCT Filed: Jun. 25, 2008
(86) PCT No.: PCT/EP2008/058083

§ 371 Date: Dec. 23, 2010

(51) Int. Cl. A47J 31/44; A23L 1/00

(52) U.S. Cl. 99/293; 99/323.3

(57) ABSTRACT

A device for heating and/or frothing milk for machines for preparing hot beverages such as a cappuccino, comprising a tubular body inside which a Venturi tube is provided which has an intake end which can be associated with a source of steam and a discharge end, a mixing chamber, which is defined between a converging portion and a diverging portion of the Venturi tube, and at least one milk supply duct, which has a drawing port which can be associated with a milk reservoir and a port for introducing the milk in the mixing chamber, the milk being drawn into the mixing chamber due to the partial vacuum created by the flow of steam between the converging portion and the diverging portion of the Venturi tube.

### TECHNICAL FIELD

The present invention relates to a device for heating and/or frothing milk to prepare hot beverages such as a cappuccino.

### BACKGROUND ART

It is known that coffee making machines are provided with a device for dispensing steam at high temperature, by means of which milk is heated and/or frothed in order to prepare hot beverages, such as for example a cappuccino or a warm milk.

In the jargon of the field, this device is known as frother.

Known frothers comprise a tubular element in which the inlet end is associated with a source of steam at high temperature, and the outlet end is provided with a nozzle for dispensing the steam.

Moreover, known frothers comprise a tap for blocking and adjusting the flow of steam, which is provided with an actuation knob.

In use, an operator manually arranges the tubular element inside a container, such as a cup, jug or the like, which contains cold milk, and places the nozzle below or at the free surface of the milk, depending on whether he wishes to heat it or also froth it, i.e., produce a surface layer of foam.

The operator then opens the tap and adjusts it according to his own sensibility in order to obtain in output from the nozzle a flow of steam which is suitable for the situation. In particular, in order to obtain frothed milk, the operator opens and closes the tap repeatedly as he simultaneously moves the container of the milk toward and away from the nozzle, so that the flow of steam incorporates air to form the foam.

These known frothers, however, suffer drawbacks, among which it is necessary to note that the production of warm milk or frothed milk depends on the sensibility and experience that the operator has in arranging the nozzle at the correct level and in adjusting the degree of opening of the tap.

Another drawback of known frothers consists in that they work with the tubular element arranged vertically or at most obliquely, and this forces design and manufacturing constraints of the machines to which they are applied.

Another drawback of known frothers consists in that residues of milk and dirt accumulate on the outer surface of the tubular element and of the nozzle and must be removed manually with the aid of sponges and washing liquids. However, these operations do not ensure a high and safe degree of hygiene, so that harmful bacterial colonies can grow from the residues of milk and dirt.

### DISCLOSURE OF THE INVENTION

The aim of the present invention is to devise a device for heating and/or frothing milk for machines for preparing hot beverages such as a cappuccino, whose operation is regular, constant and independent of the sensibility and experience of an operator, thus allowing to obtain milk which is warmed and/or frothed to a preset degree.

An object of the present invention is to devise a device for heating and/or frothing milk which is versatile and flexible in use and can be installed easily on any machine for making hot beverages without requiring particular modifications or interventions for adaptation.

Still another object of the present invention is to provide a device for heating and/or frothing milk which can be cleaned easily so as to ensure a high degree of hygiene.

Within this aim, another object of the present invention is to provide a device which is simple, relatively easy to provide in practice, safe in use, effective in operation, and relatively low in cost.

This aim and these and other objects are all achieved by the present device for heating and/or frothing milk for machines for preparing hot beverages such as cappuccino, characterized in that it comprises a tubular body inside which there is a Venturi tube which has an intake end which can be associated with a source of steam and a discharge end, a mixing chamber, which is defined between the converging portion and the diverging portion of the Venturi tube, and at least one milk supply duct, which has a drawing port which can be associated with a milk reservoir and a port for introducing the milk in the mixing chamber, the milk being drawn into the mixing chamber due to the partial vacuum created by the flow of steam between the converging portion and the diverging portion of the Venturi tube.

In a preferred embodiment, the device according to the invention also comprises an ambient air supply duct, which has an intake port adapted to be connected to the outside environment and a port for introducing the air in the mixing chamber, the air being drawn into the mixing chamber due to the partial vacuum created by the flow of steam between the converging portion and the diverging portion of the Venturi tube.

In another preferred embodiment, the device according to the invention comprises a tap which is associated with the air supply duct for opening and closing the air intake port.

### BRIEF DESCRIPTION OF THE DRAWINGS

Further characteristics and advantages of the present invention will become better apparent from the detailed description of a preferred but not exclusive embodiment of a device for heating and/or frothing milk for machines for making hot beverages such as cappuccino, according to the invention, illustrated by way of non-limiting example in the accompanying drawings, wherein:

FIG. 1 is an exploded perspective view of the device according to the invention;

FIG. 2 is a general perspective view of the device according to the invention;

FIG. 3 is a sectional view of the device according to the invention, taken along the central longitudinal plane;

FIG. 4 is an enlarged-scale view of the air supply duct of the device according to the invention with the tap in the open configuration;

FIG. 5 is a sectional view, taken along a plane which is perpendicular to the longitudinal axis of the air supply duct;

FIG. 6 is a sectional view, taken along the line VI-VI of FIG. 5;

FIGS. 7, 8 and 9 correspond to FIGS. 4, 5 and 6, but with the tap in the closed configuration.

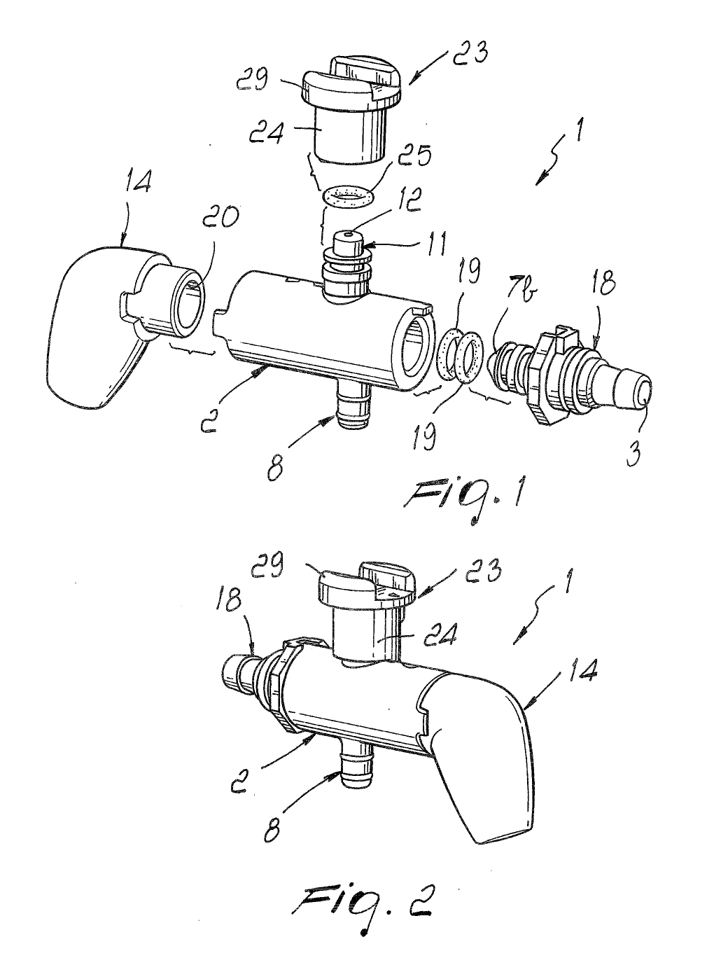

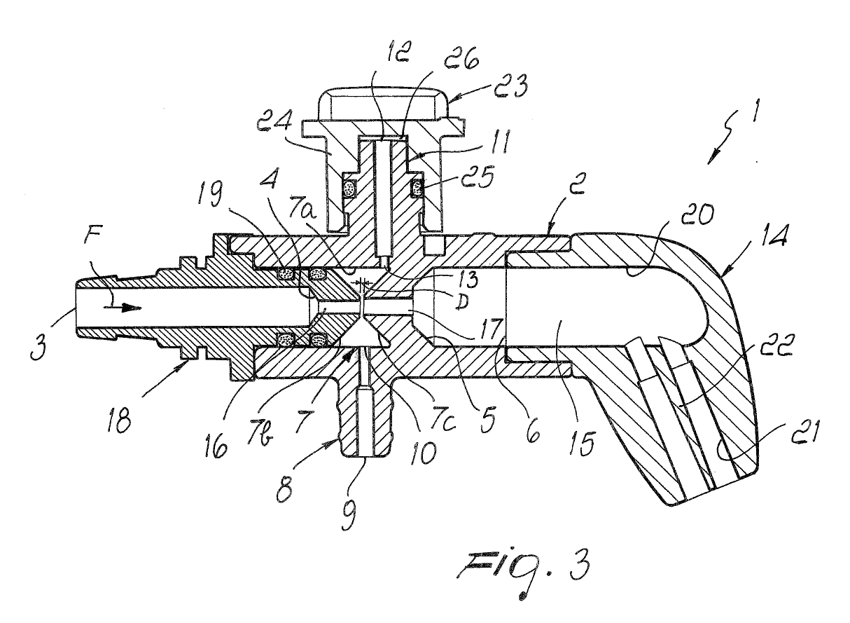

### WAYS OF CARRYING OUT THE INVENTION

With reference to the figures, the reference numeral 1 generally to designates a device for heating and/or frothing milk for machines for preparing hot beverages such as cappuccino.

In the present description, the term “substantially” is used with a meaning of “correspondence” within tolerances which are known to the person skilled in the art.

The device 1 comprises a tubular body 2, inside which a Venturi tube is provided which comprises an intake end 3, a converging portion 4, a diverging portion 5 and a discharge end 6.

The intake end 3 can be associated with a source of steam, such as for example a boiler, a pressurized boiler, an instant heat exchanger (Thermoblock).

The flow of steam passes through the Venturi tube along Inc direction indicated by the arrow F.

Between the converging portion 4 and the diverging portion 5 there is a chamber 7 for mixing the milk with the steam and optionally with air drawn from outside.

The device 1 further comprises at least one milk supply duct 8, which has a drawing port 9 which can be associated with a milk reservoir, not shown, and a milk input port 10, which leads into the mixing chamber 7.

The milk is drawn from the reservoir into the mixing chamber 7 due to the partial vacuum created by the acceleration of the flow of steam between the converging portion 4 and the diverging portion 5.

Moreover, the device 1 comprises at least one duct 11 for supplying air from the outside environment, which has an intake port 12 adapted to be connected to the outside environment and an air input port 13 which leads into the mixing chamber 7.

In this case also, the air is drawn from the outside into the mixing chamber 7 due to the partial vacuum created by the acceleration of the flow of steam between the converging portion 4 and the diverging portion 5.

A dispenser 14 for the milk heated and/or frothed in the mixing chamber 7 is associated with the end of the tubular body 2 at which the discharge end 6 of the Venturi tube leads out.

A chamber 15 for compacting the heated and/or frothed milk that exits from the mixing chamber 7 is defined between the diverging portion 5 and the dispenser 14.

The milk supply duct 8 and the air supply duct 11 are connected to the tubular body 2 and are arranged substantially perpendicular to the longitudinal axis of the Venturi tube and are mutually offset with respect to the direction of the flow of steam.

In particular, the milk input port 10 is offset backwardly with respect to the air input port 13.

The mixing chamber 7 is defined by a cylindrical portion 7a, which is formed inside the tubular body 2 and is hollow and coaxial with respect to the Venturi tube, and by two surfaces 7b and 7c which are substantially frustum-shaped and face each other, so as to be opposite one another, within the cylindrical portion 7a.

The two frustum-shaped surfaces 7b and 7c are arranged substantially coaxially to the cylindrical portion 7a and their respective smaller end faces are mutually juxtaposed and adjacent at a preset distance D.

The milk input port 10 and the air input port 13 are provided at the lateral surface of the cylindrical portion 7a.

The smaller end faces of the two mutually juxtaposed frustum-shaped surfaces 7b and 7c define the region at which the aspirated milk and air meet.

The annular volume that lies at the peripheral portion of such region defines the space within which, due to turbulent motions, the milk is frothed by the air, forming foam.

The Venturi tube comprises a first tubular portion 16, which connects the converging portion 4 to the mixing chamber 7, and a second tubular portion 17, which connects the mixing chamber 7 to the diverging portion 5.

The first tubular portion 16 and the second tubular portion 17 are substantially coaxial, and the first portion has a smaller inside diameter than the second portion.

The discharge end of the first tubular portion 16 and the intake end of the second tubular portion 17 are provided at the smaller end faces of the two frustum-shaped surfaces 7b and 7c which are mutually juxtaposed.

In the embodiment shown in the accompanying figures, the intake end 3, the converging portion 4 and the first tubular portion 16 of the Venturi tube are provided in a nozzle 18.

The nozzle 18 has an end which is inserted detachably within the tubular body 2 with the interposition of sealing rings 19 and an opposite end which protrudes from the tubular body 2 and is provided with means for coupling or engagement with a machine for preparing hot beverages.

The end of the nozzle 18 that is inserted within the tubular body 2 is frustum-shaped, so as to define the frustum-shaped surface 7b.

The other frustum-shaped surface 7c is instead defined on one face of a partition which is formed within the tubular body 2 and is crossed by the second tubular portion 17.

The diverging portion 5 is provided on the opposite face of such partition.

The dispenser 14 is associated detachably with the tubular body 2 and comprises an internal cavity 20 which defines, in association with the tubular body 2, the compaction chamber 15 and is connected to a channel 21 for the outflow of the warmed and/or frothed milk.

The outflow channel 21 is crossed by at least one longitudinal fin 22, which improves the flow of milk in output, contributing to give a “cream” effect to the frothed milk.

Both the nozzle 18 and the dispenser 14 are coupled to the tubular body 2 by interlocking coupling or other temporary couplings which are known to the person skilled in the art. In particular, both the nozzle 18 and the dispenser 14 have an end which can be inserted substantially snugly within a corresponding open end of the tubular body 2, reference notches or tabs being further provided.

The device 1 further comprises a tap 23, which is associated with the air supply duct 11 to open and close the air intake port 12.

The tap 23 is of the “open/close” type; i.e., it assumes two configurations: an open configuration, in which the air intake port 12 is connected to the outside environment, and a closure configuration, in which the air intake port 12 is isolated with respect to the outside environment.

The tap 23 could be replaced by any suitable air regulator elements or electrovalve.

In the open configuration, the air is aspirated into the mixing chamber 7 due to the partial vacuum created by the acceleration of the flow of steam in the converging portion 4 of the Venturi tube, so that the milk drawn into the mixing chamber 7, in addition to being heated by the steam, is also emulsified with the aspirated air and thus frothed, forming foam.

In the closed configuration, any inflow of air into the mixing chamber 7 is prevented, so that the milk drawn into the mixing chamber 7 is only heated by the steam and is not also frothed.

In the embodiment shown in the accompanying figures, the tap 23 comprises a cup-shaped element 24, which is coupled rotatably to the end of the air supply duct 11, where the intake port 12 is provided, a gasket 25 being interposed between the cup-shaped element 24 and the air supply duct 11.

Between the bottom of the cup-shaped element 24 and the end of the air supply duct 11 there is an interspace 26, while the wall of the cup-shaped element 24 is crossed by a through hole 27 which is perpendicular to the air supply duct 11.

A recess 28 is formed on the outer lateral surface of the air supply duct 11 and is connected to the interspace 26.

Conveniently, at the upper end of the cup-shaped element 24 an actuation handwheel 29 is provided, which is adapted to facilitate grip and handling by an operator.

The cup-shaped element 24 turns between the open configuration and the closed configuration.

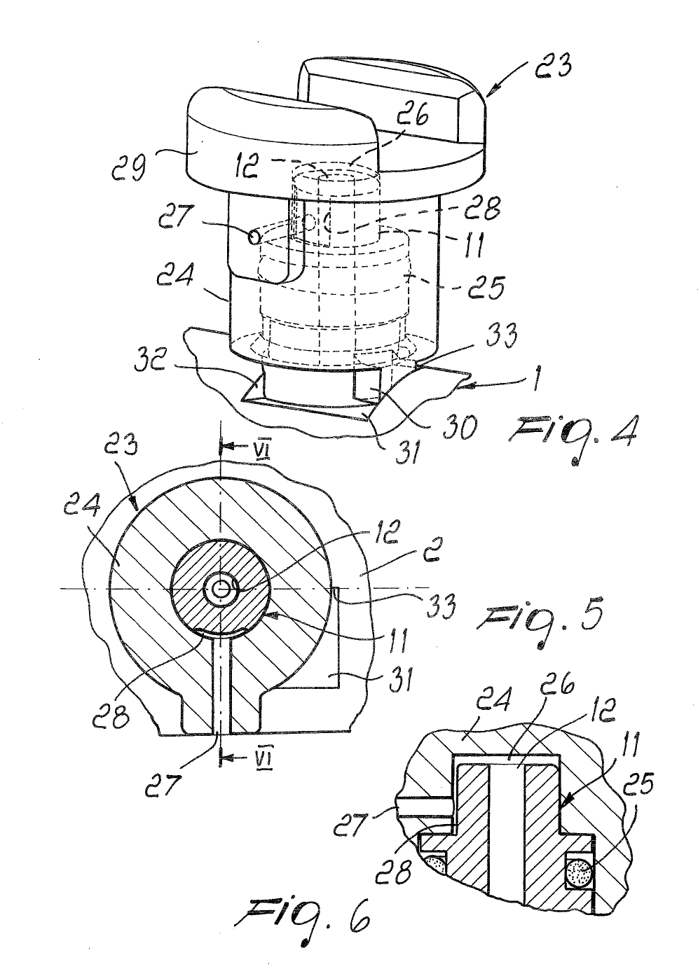

In the open configuration (FIGS. 4-6), the hole 27 engages the recess 28, so that the air can flow into the mixing chamber 7 along the path defined by the hole 27, by the interspace 26 and by the air supply duct 11.

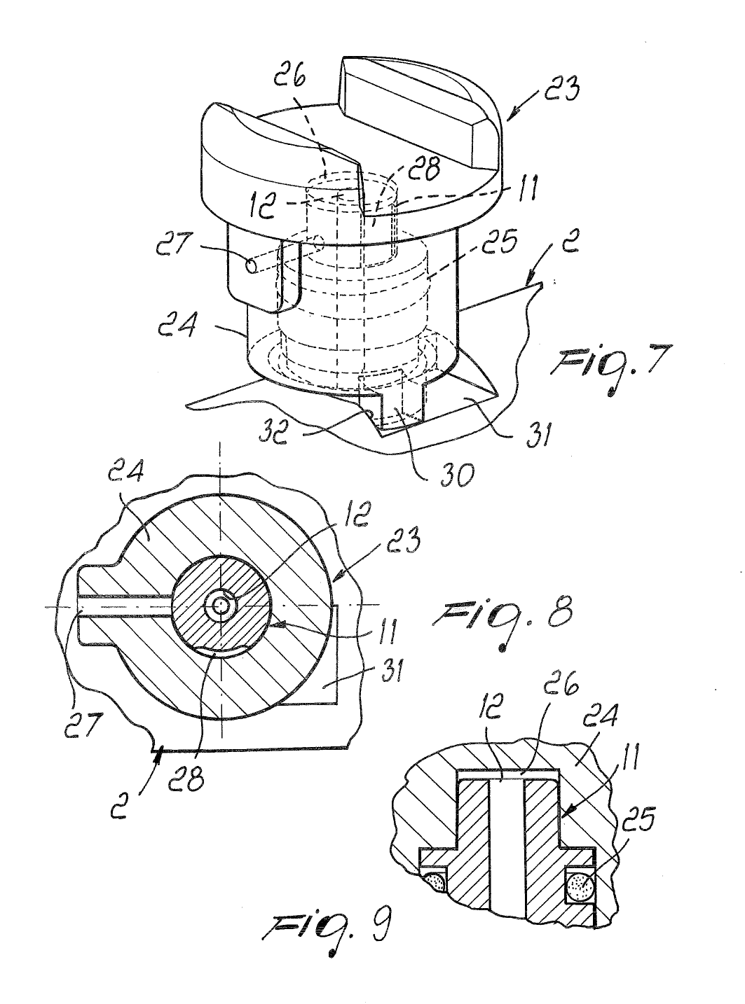

In the closed configuration (FIGS. 7-9), in which the cup-shaped element 24 is rotated through an angle of 90° with respect to the open configuration, the hole 27 is excluded from the recess 28, thus preventing the inflow of the air from outside to the intake port 19.

Means are also provided for stopping the rotation of the cup-shaped element 24 in the open configuration and in the closed configuration.

These stop means comprise at least one tooth 30 which protrudes from the cup-shaped element 24 and is accommodated so that it can slide within a groove 31 defined in the tubular body 2, an abutment surface 32 and 33 of the tooth 30 being defined at each of the two opposite ends of the groove 31 in order to stop the cup-shaped element 24 respectively in the closed configuration and in the open configuration.

Operation of the device according to the invention is as follows.

The device 1 is applied to any machine for making hot beverages which has a high-temperature steam source; this application is facilitated by the coupling or insertion means provided at the end of the nozzle 18.

The source of steam is connected to the intake end 3, while the milk supply duct 8 is connected, by means of a tube inserted therein, to a milk reservoir or container.

If one wishes to prepare warm milk without froth, the tap 23 is arranged in the closed configuration, in which the hole 27 does not engage the recess 28, preventing the inflow of air from the outside to the inside of the mixing chamber 7.

In this configuration, the flow of steam that passes through the Venturi tube undergoes, in passing through the converging portion 4, such an acceleration as to create a partial vacuum which is sufficient to draw the milk into the mixing chamber 7.

The milk thus aspirated combines with the steam and warms up, and after passing through the compaction chamber 15 is dispensed through the outflow channel 21 of the dispenser 14.

If one wishes to obtain frothed warm milk, i.e., with foam, it is sufficient to turn the tap 23 through 90° and move it to the open configuration, in which the hole 27 engages the recess 28, connecting the air supply duct 11 to the outside environment.

In this case, the partial vacuum generated by the acceleration that the flow of steam undergoes in passing through the converging portion 4 is such as to draw into the mixing chamber 7 not only the milk but also air.

The milk and the air mix with the steam, forming foam. The milk thus frothed and heated passes through the compaction chamber 15, where it compacts again, to be then dispensed through the outflow channel 21 of the dispenser 14.

It is noted that the operations for cleaning the device 1 are particularly simple and effective; it is in fact sufficient to draw water instead of milk through the supply duct 8 in order to obtain, due to the heat of the flow of steam, the complete removal of any residue of milk and of any particle of dirt.

Moreover, it is noted that no residues of milk accumulate on the outside of the device 1; the heating and frothing of the milk in fact occur inside the device 1.

In practice it has been found that the described invention achieves the proposed aim and objects.

The device according to the invention in fact allows to obtain warm and/or frothed milk at a degree and a level which are constant and independent of the sensibility and experience of the operator.

The device according to the invention is simple to use and does not require particular manual skill of the operator; it is in fact sufficient to turn the tap in one of the two positions to obtain either warm milk or warm and frothed milk.

Moreover, the device according to the invention is flexible and versatile in use; it can in fact be applied to any machine without particular constructive constraints and without requiring particular structural modifications, and it can also operate arranged in any orientation.

Finally, the device according to the invention ensures a high degree of hygiene and sterilization.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the protection of the appended claims.

1-21. (canceled)

22. A device for heating and/or frothing milk for machines for preparing hot beverages such as cappuccino, comprising a tubular body inside which there is a Venturi tube which has an intake end which can be associated with a source of steam and a discharge end, a mixing chamber, which is defined between a converging portion and a diverging portion of said Venturi tube, and at least one milk supply duct, which has a drawing port which can be associated with a milk reservoir and a port for introducing the milk in said mixing chamber, the milk being drawn into said mixing chamber due to the partial vacuum created by the flow of steam between said converging portion and said diverging portion.

23. The device according to claim 22, further comprising at least one duct for supplying ambient air which has an intake port connected to the outside environment and an input port for introducing the air in said mixing chamber, the air being drawn into said mixing chamber due to the partial vacuum created by the flow of said steam between said converging portion and said diverging portion.

24. The device according to claim 22, further comprising a dispenser of the milk that has been heated and/or frothed in said mixing chamber, which is associated with said tubular body downstream, in the direction of the flow of said steam, of said discharge end of the Venturi tube.

25. The device according to claim 24, further comprising a chamber for compacting the heated and/or frothed milk, which is defined between said diverging portion and said dispenser.

26. The device according to claim 22, wherein said mixing chamber is defined by a cylindrical portion, which is hollow and substantially coaxial to said Venturi tube, and by two surfaces which are substantially frustum-shaped and face the inside of said cylindrical portion and are arranged coaxially thereto and so that their respective smaller end faces are mutually juxtaposed and adjacent at a preset distance.

27. The device according to claim 26, wherein said milk input port is provided on the lateral surface of said cylindrical portion.

28. The device according to claim 23, wherein said air input port is provided on the lateral surface of said cylindrical portion.

29. The device according to claim 23, wherein said milk input port is offset backwardly with respect to said air input port relative to the direction of flow of the steam.

30. The device according to claim 23, wherein said milk supply duct and said air supply duct are connected to said tubular body and are arranged substantially at right angles to said Venturi tube.

31. The device according to claim 22, wherein said Venturi tube comprises a first tubular portion which connects said converging portion to said mixing chamber and a second tubular portion which connects said mixing chamber to said diverging portion, said first tubular portion and said second tubular portion being substantially coaxial.

32. The device according to claim 31, wherein said first tubular portion has an inside diameter which is smaller than the inside diameter of said second tubular portion.

33. The device according to claim 31, wherein said intake end, said converging portion and said first tubular portion of the Venturi tube are defined in a nozzle which has an end inserted detachably in said tubular body and an opposite end which protrudes from said tubular body and is provided with means for coupling to a machine for preparing hot beverages.

34. The device according to claim 33, wherein the end of said nozzle that is inserted in said tubular body is frustum-shaped so as to define one of said frustum-shaped surfaces.

35. The device according to claim 34, wherein the other one of said frustum-shaped surfaces and said second tubular portion and said diverging portion of the Venturi tube are provided in said tubular body.

36. The device according to claim 24, wherein said dispenser is associated detachably with said tubular body and comprises an internal cavity which defines, in association with said tubular body, said compaction chamber and is connected to a channel for the outflow of the warm and/or frothed milk.

37. The device according to claim 36, wherein said dispenser comprises at least one longitudinal fin which passes through said outflow channel.

38. The device according to claim 23, further comprising a tap which is associated with said air supply duct for opening and closing said air intake port.

39. The device according to claim 38, wherein said tap comprises a cup-shaped element which is coupled rotatably to the end of said air supply duct where said intake port is provided, between the bottom of said cup-shaped element and said end of said air supply duct there being an interspace, a through hole, which passes through the wall of said cup-shaped element, and a recess, which is defined on the outer lateral surface of said air supply duct and is connected to said interspace, said cup-shaped element being movable between an open configuration, in which said hole affects said recess for the inflow of the air from outside to said intake port through said hole, said recess and said interspace, and a closed configuration, in which said hole is excluded from said recess, preventing the inflow of the air from outside to said intake port.

40. The device according to claim 39, further comprising means for stopping the rotation of said cup-shaped element in said open configuration and in said closed configuration.

41. The device according to claim 40, wherein said stop means comprise at least one tooth which extends from said cup-shaped element and is accommodated so that it can slide within a groove defined in said tubular body, at each of the two opposite ends of said groove there being a surface for the abutment of said tooth for stopping said cup-shaped element respectively in said open configuration and in said closed configuration.

42. A machine for preparing hot beverages such as cappuccino or the like, comprising a source of steam with which a device according to claim 22 is associated.
